(19) United States
(12) Patent Application Publication
(10) Pub. No.: US 2014/0149906 A1
(43) Pub. Date: May 29, 2014

(54) Electronic Bookshelf

(71) Applicant: BANK OF AMERICA CORPORATION, Charlotte, NC (US)

(72) Inventors: Venkat R. Pillay, Robbinsville, NJ (US); Paulo Resende, Robbinsville, NJ (US); Bharat Raj Varla, Lawrenceville, NJ (US); Devi Shanmuga Kumar, West Windsor, NJ (US)

(73) Assignee: Bank of America Corporation, Charlotte, NC (US)

(21) Appl. No.: 13/685,155

(22) Filed: Nov. 26, 2012

(51) Int. Cl. G06F 3/0481; G06F 3/0486

(52) U.S. Cl. CPC G06F 3/04817; G06F 3/0486
USPC 715/769; 715/835

(57) ABSTRACT

According to one embodiment, one or more computer-readable non-transitory storage media may embody software that is operable, when executed, to present, on a display, a plurality of applications available for execution. The software may further receive a selection of an application from the plurality of applications and communicate a request associated with the application in response to receiving the selection. The software may then receive, in response to the request, the application in a packaged form. The packaged form may correspond to an operating system associated with the media. The software may also unpackage the application in order for the application to be executed and present, on the display, the results of executing the application.

### TECHNICAL FIELD

This disclosure relates generally to an apparatus for displaying applications and literature.

### BACKGROUND

The development and distribution of applications and electronic literature has expanded to multiple contexts and operating systems. With each new context and operating system, technical challenges associated with development and distribution increase.

### SUMMARY OF THE DISCLOSURE

According to one embodiment, one or more computer-readable non-transitory storage media may embody software that is operable, when executed, to present, on a display, a plurality of applications available for execution. The software may further receive a selection of an application from the plurality of applications and communicate a request associated with the application in response to receiving the selection. The software may then receive, in response to the request, the application in a packaged form. The packaged form may correspond to an operating system associated with the media. The software may also unpackage the application in order for the application to be executed and present, on the display, the results of executing the application.

According to another embodiment, an apparatus may store a plurality of applications. The apparatus may further receive a request associated with initiating execution of an application in the plurality of applications and package the application based at least in part upon an operating system associated with the request. The apparatus may then communicate at least a portion of the packaged application in response to the request in order for the application to execute.

Certain embodiments may provide one or more technical advantages. A technical advantage of one embodiment includes reducing the demand on electronic storage. Another technical advantage may include reducing the technical challenges associated with developing applications. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates a system for communicating applications and literature;

FIG. 2 illustrates a device of the system of FIG. 1 for presenting applications and literature;

FIG. 3 illustrates a device of the system of FIG. 1 for presenting applications and literature;

FIG. 4 illustrates a device of the system of FIG. 1 for composing applications and literature; and

FIG. 5 is a flowchart illustrating a method of presenting and composing applications and literature.

### DETAILED DESCRIPTION

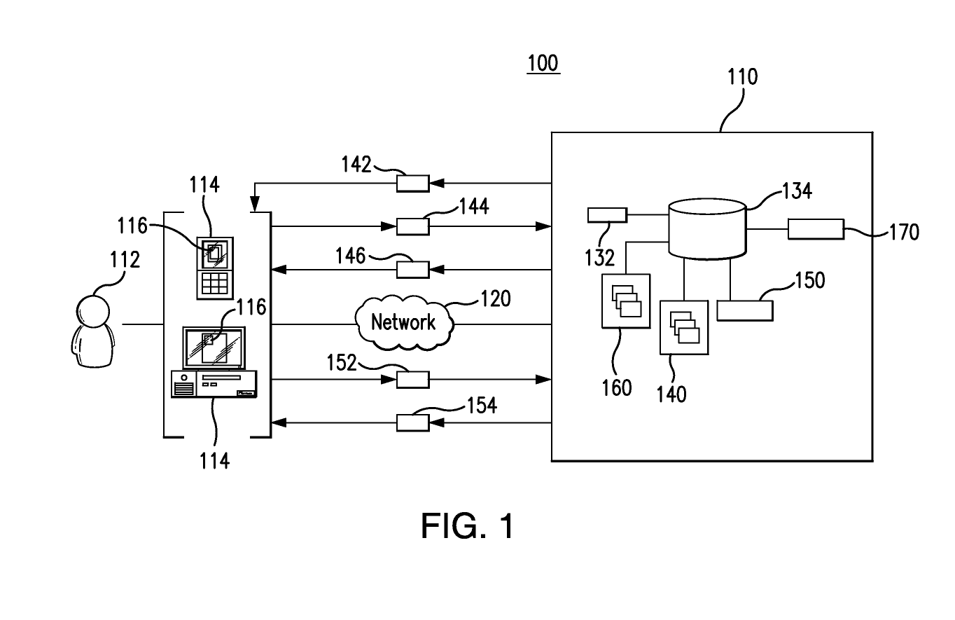

Embodiments of the present disclosure and its advantages are best understood by referring to FIGS. 1 through 5 of the drawings, like numerals being used for like and corresponding parts of the various drawings.

A user may use system 100 to execute and/or view applications and literature. For example, the user may work in a particular industry and may be interested in brochures specific to that industry. When a new industry brochure is available, system 100 may alert the user of the availability of the new brochure. The user may then execute an application that provides an interface through which the user may view the new brochure.

As another example, the user may be an employee who is trying to calculate expenditures for the coming year by using a calculator associated with the particular industry. The user may wish to execute the calculator on multiple devices such as a mobile device and/or a personal computer. However, the user may not understand how to package and/or install a particular version of the calculator that corresponds to the device and/or an operating system associated with the device that will execute the calculator. In this situation, the user may execute the application and request to execute the calculator from the application. The application may then request an appropriately packaged calculator that will execute on the device executing the application.

The application may provide the user with an interface through which the user may see available applications and/or literature. For example, the interface may include a shelf that contains electronic representations of books, boxes, and/or any suitable physical objects. These electronic representations represent available literature and/or applications. For example, a brochure that is available for the user to view may be shown as a book on the shelf. As another example, the calculator may be shown as a box on the shelf. When the user selects the book and/or the box, the calculator may execute and/or the brochure may open for viewing.

When the user is executing an available application, such as the calculator, the results of executing the available application may be displayed within the results of executing the application. For example, the application may display a shelf that contains applications and literature that are available to the user. One such application may be a calculator. If the user chooses to execute the calculator, then the calculator may appear within the shelf. In this manner, the shelf forms a frame around the display of the calculator. From the user's perspective, a context shift from the application to the calculator has not occurred. After the user has finished executing the calculator, the calculator may close back into a box on the shelf and the user may select something else from the shelf to view and/or execute.

The shelf may contain a box associated with a composer application that the user may use to compose literature and/or applications. The composer application may remove some of the technical challenges associated with designing applications. For example, the user may drag and drop portions of a design onto a display. The composer may also allow the user to easily define the functionality of the portions that have been dropped onto the display. After the user has finished composing the application, the system may publish the application to the user's shelf and to the shelves of other designated users. When those users execute the application, the system may package the application according to the device and/or operating system of that user. In this manner, the user may compose an application that may be executed by a variety of devices.

By using particular embodiments of the system, technical challenges associated with designing applications may be removed. For example, the system may package an application to be executed by a device that is different than the device used to design the application. In this manner, the user who designed the application will not need to design multiple versions of the application to suit multiple types of devices. Furthermore, by using particular embodiments of the system, the demand on storage may be reduced. For example, applications may be stored in a central repository and devices may retrieve these applications from the central repository as needed.

FIG. 1 illustrates a system 100 for communicating applications 140 and literature. System 100 includes device 114, network 120, and server 110. Server 110 may be communicatively coupled to device 114 through network 120. User 112 may use system 100 to compose, publish, distribute, and/or execute applications and literature.

User 112 may use a device 114 to interact with system 100. For example, user 112 may use device 114 to compose an application 140. Furthermore, user 112 may use device 114 to execute and/or view literature 160 and application 140. Device 114 may be a mobile device such as a cell phone or tablet. Device 114 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 100. Device 114 may also include a user interface, such as a display, a touchscreen, a microphone, keypad, or other appropriate terminal equipment usable by user 112.

Device 114 may include a processor and a memory. The memory may store an application 116 comprising lines of code executable by the processor. When executed, application 116 may aid user 112 in composing, executing, and/or viewing literature 160 and application 140. For example, application 116 may present on the display of device 114 a shelf that contains available literature 160 and available applications 140. When user 112 selects a piece of literature 160 to view or an application 140 to execute, application 116 may communicate the selection to server 110. Server 110 may then respond with the selected literature 160 or the selected application 140. Application 116 may then display the contents of the selected literature 160 and/or the results of executing the selected application 140.

Application 116 may provide an interface through which user 112 may see available literature 160 and/or available applications 140. For example, application 116 may present, on a display of device 114, a shelf that holds available literature 160 and/or available applications 140. Available literature 160 may be depicted as books on the shelf and available applications 140 may be depicted as boxes on the shelf. User 112 may determine the literature 160 that is available for viewing and the applications 140 that are available for execution by looking at the shelf. User 112 may select a book representing available literature 160 or a box representing available application 140 in order to view the available literature 160 or to execute the available application 140. This disclosure contemplates available literature 160 and available applications 140 being depicted as any suitable object.

Application 116 may communicate authentication parameters to server 110 in order to authenticate user 112. The authentication parameters may include a username and a password associated with user 112. After user 112 is authenticated, application 116 and/or server 110 may determine which application 140 and literature 160 are available to user 112. Applications 140 and literature 160 that are available to user 112 may be associated with the authentication parameters. After the user 112 is authenticated, server 110 and/or application 116 may perform other functions specific to user 112 such as for example, blocking particular communications and/or packaging a requested application 140.

Application 116 includes a viewer through which user 112 may examine the contents of selected literature 160 and/or view the results of executing selected application 140. Application 116 may present the viewer in a region of the display of device 114 such that a portion of the shelf frames the viewer. In this manner, the contents of selected literature 160 and the results of executing selected application 140 may be presented in at least a portion of the shelf. Therefore, when user 112 views the contents of selected literature 160 and/or the results of executing selected application 140, this simulates viewing the contents and/or the results in the context of the shelf, which improves the end-to-end user experience.

Application 116 may further provide an interface through which user 112 may design and/or compose an application 140. The interface may provide user 112 with templates and tools with which user 112 may intuitively design and compose the application 140. For example, the interface may provide user 112 with text boxes, text fields, picture boxes, and any other suitable templates and/or tools. User 112 may drag and drop these templates and/or tools into certain regions of the display in designing the application 140. For example, user 112 may drag and drop a text box next to a text field and label the text box “Name.” The resulting application 140 may then show the word “Name” next to a text field in which a user 112 may enter his name.

The interface may be provided through an available application 140. For example, when executing application 116 device 114 may present a shelf containing various boxes representing available applications 140. One box may be labeled composer, which indicates that that box represents the composer application. When user 112 selects the box labeled composer, device 114 may execute the composer application that provides the interface through which user 112 may compose and/or design other applications 140.

When user 112 has completed designing and/or composing an application 140, system 100 may store the application 140 and publish its availability to other users 112. User 112, who designed and/or composed the application 140, may designate the other users 112 that may access the designed application 140. After the application 140 has been published, the other users 112 may view the designed application 140 on their shelves, which may be represented as a box on the shelf. When a user 112 selects the box in order to execute the application 140, system 100 may package the application 140 so that the application 140 may execute properly on the user's 112 device. For example, system 100 may compile, compress, determine an installer, and/or perform any suitable functions according to any suitable property of the user's 112 device 114, such as hardware specifications and operating system. In this manner, user 112 may execute the application 140 using a device 114 that is different from the device 114 used to design the application 140. For example, the application 140 may have been designed on a personal computer and user 112 may execute the application 140 on a cell phone.

System 100 includes a network 120 that facilitates communications between device 114 and server 110. This disclosure contemplates any suitable network 120 operable to facilitate communication between the components of system 100. Network 120 may include any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

System 100 may include a server 110. Server 110 may perform the storage, packaging, and distribution functions of system 100. For example, server 110 may store literature 160 and applications 140. Furthermore, server 110 may include a composer 150 that composes and/or packages applications 140 and literature 160. Server 110 may reduce the demands on storage by storing available literature 160 and applications 140 centrally. In this manner, users 112 may view literature 160 and execute applications 140 without keeping static copies of literature 160 and applications 140 in device 114.

Server 110 includes a processor 132 and a memory 134 that perform the functions described herein. For example, memory 134 may perform the storage functions of server 110. Memory 134 may store, either permanently or temporarily, data, operational software, or other information for processor 132. Memory 134 may include any one or a combination of volatile or non-volatile local or remote devices suitable for storing information. For example, memory 134 may include random access memory (RAM), read only memory (ROM), magnetic storage devices, optical storage devices, or any other suitable information storage device or a combination of these devices.

Processor 132 may control the operation and administration of server 110 by processing information received from network 120 and memory 134. Processor 132 may include any hardware and/or software that operates to control and process information. Processor 132 may be a programmable logic device, a microcontroller, a microprocessor, any suitable processing device, or any suitable combination of the preceding.

Server 110 may store available literature 160 and available applications 140. Server 110 may publish available literature 160 and available applications 140 to particular users 112 according to a permission 170. For example, the permission 170 may limit the publication of a medical brochure to employees of a particular healthcare company. In order to follow the permission 170, server 110 may publish the available medical brochure to the shelves of the employees of that particular healthcare company but not to other users 112. The employees of that particular healthcare company would then see the medical brochure in their shelves but other users 112 would not see the medical brochure appear in their shelves.

When a user 112 requests an available literature 160 or an available application 140, server 110 may package and distribute the requested literature 160 or application 140. Packaging may include any suitable function so that an end device 114 may open the literature 160 and/or execute the application 140. For example, server 110 may format requested literature 160 or convert requested literature 160 into a format such that an end device 114 may display the requested literature 160. As another example, server 110 may compile and determine an appropriate installer for a requested application 140 so that the end device 114 may install and execute the requested application 140.

Server 110 may include a composer 150 that formats and packages literature 160 and/or applications 140. For example, as user 112 composes an application 140, composer 150 may assemble the desired application 140. Server 110 may receive commands as the user 112 composes the application 140, and composer 150 may assemble the desired application 140 based on these commands. These commands may have been first received by device 114 as user 112 composes the application 140. Device 114 may then communicate the received command to server 110. When user 112 has completed composing the application 140, composer 150 may store the completed application 140 in a proper format. As another example, when user 112 requests an available application 140, composer 150 may retrieve the application 140 and based on particular features of the end device 114, such as hardware specifications and/or operating system, composer 150 may compile and/or attach an appropriate installer to the requested application 140 so that the end device 114 may properly execute the requested application 140. As yet another example, composer 150 may format requested literature 160 and/or convert requested literature 160 into an appropriate format for an end device 114. In this manner, the end device 114 may receive literature 160 and applications 140 that are suitable for the end device 114 to open and/or execute.

Server 110 may include permissions 170. Permissions 170 may limit access to literature 160 and/or applications 140. For example, server 110 may limit access to an application 140 to a particular set of users 112 according to permissions 170. That particular set of users 112 may see the application 140 in their shelves but other users may not. Server 110 may further block a portion of literature 160 and/or application 140 according to a permission 170. For example, permission 170 may allow executives to view a particular portion of a piece of literature 160 but not other users 112. When a user 112 who is not an executive requests the piece of literature 160, server 110 may redact the portion of literature 160 that the user 112 is not allowed to see.

In operation, system 100 may provide for the viewing of literature 160, the execution of application 140, and the composing, packaging, and distribution of literature 160 and/or applications 140. Particular communications between device 114 and server 110 may facilitate the operation of system 100.

Server 110 may communicate a message 142 to device 114 in order to communicate the literature 160 and applications 140 that are available to a user 112 associated with device 114. Message 142 may include the title and an identifier associated with each piece of literature 160 and each application 140 that is available to the user 112. For example, user 112 may be a manager. According to permission 170, managers may access a performance report. Based on the permission 170, server 110 may communicate a message 142 that includes the title and identifier associated with the performance report to a device 114 of the manager. Upon receiving the message 142, device 114 may depict a book with the title of the performance report. The manager may then select the book to view the performance report. As another example, the permission 170 may allow managers to access an inventory calculator. Based on this permission 170, the communicated message 142 may include a title and identifier associated with the inventory calculator. When device 114 receives the message 142, device 114 may depict in the manager's shelf a box labeled with the title of the inventory calculator. When user selects the box, device 114 may execute the inventory calculator.

After user 112 has selected to view a piece of literature 160 or to execute an application 140, device 114 may communicate a request 144 to server 110. The request 144 may include the title and/or the identifier associated with the selected literature 160 and/or application 140. When server 110 receives the request 144, server 110 may examine the request 144 to determine which literature 160 or application 140 is requested. After determining the requested literature 160 or application 140, server 110 may format, convert, and/or package the requested literature 160 or application 140. By formatting, converting, and/or packaging the requested literature 160 or application 140, server 110 may provide the end device 114 with literature 160 and/or application 140 that is appropriate for the end device 114.

Server 110 may communicate a package 146 to device 114 after server 110 has formatted, converted, and/or packaged literature 160 or application 140. In the case of literature 160, the package 146 may include the contents of the requested literature 160 in a format that the end device 114 may open. For example, the end device 114 may be a cell phone with a limited display area. In that case, the package 146 may include literature 160 that has been formatted to fit in the limited display area. If user 112 requested an application 140, then package 146 may include the application 140 along with an installer that is suitable for the hardware specifications, such as processor type and the operating system of the end device 114. For example, the requested application 140 may have been compiled in a certain manner to be recognizable by a processor of the device 114 so that the processor may execute the application 140 on the operating system of the end device 114. After receiving the package 146, device 114 may unpackage the contents of the package 146. Device 114 may then display the contents of literature 160 included in the package 146 and install and/or execute the application 140 included in the package 146. By communicating message 142, request 144, and package 146, system 100 may allow user 112 to view available literature 160 and execute available applications 140.

System 100 may allow user 112 to compose applications 140 and literature 160. As previously described, device 114 may provide an interface through which user 112 may compose applications 140 and literature 160. During the composition process, device 114 may communicate commands 152 associated with various user actions that may be performed during the composition process. For example, if user 112 drags and drops a text box into a region of the interface, device 114 may communicate a command 152 to server 110 that indicates that user 112 has dragged and dropped a text box to a particular position in the interface. In response, server 110 may form an application 140 with a text box in the specified position. As another example, user 112 may drag and drop a picture into a brochure that the user 112 is composing. Device 114 may communicate a command 152 indicating the picture and its position in the brochure to server 110. In response, server 110 may form a brochure with the picture in the specified position.

After a piece of literature 160 and/or application 140 has become available, server 110 may communicate an alert 154 to device 114. The alert may indicate that the literature 160 and/or the application 140 have become available. In response, device 114 may display an alert to user 112 to let user 112 know that the literature 160 and/or application 140 have become available. Server 110 may communicate the alert 154 based on permission 170. For example, a permission 170 may indicate that a particular application should be available only to managers. If user 112 is a manager, then server 110 will communicate the alert 154 to user 112. However, if user 112 is not a manager, server 110 will not communicate the alert 154 to the user 112.

Server 110 may log user actions. Server 110 may log actions to comply with a particular regulatory scheme. For example, if a particular regulation requires server 110 to track what applications 140 are accessed by financial advisors, then server 110 may log the applications 140 that are opened by users 112 who are financial advisors. Server 110 may further log the time when the applications 140 were accessed and from where they were accessed. Server 110 may further log the request 142 communicated by device 114. As another example, server 110 may log screenshots of a device 114 of a user 112 to comply with a regulation that requires server 110 to track what a user 112 sees. By keeping the log, server 110 may maintain a record of what actions a particular user 112 has performed and what that user 112 has seen. This disclosure contemplates server 110 logging any suitable action associated with applications 140.

By using system 100, demands on electronic storage may be reduced. For example, user 112 may access literature 160 and/or applications 140 without maintaining static copies of literature 160 and/or applications 140 in device 114. Furthermore, by using system 100 user 112 may design and compose literature 160 in applications 140 for multiple types of devices 114 without having to design multiple versions of literature 160 and/or applications 140.

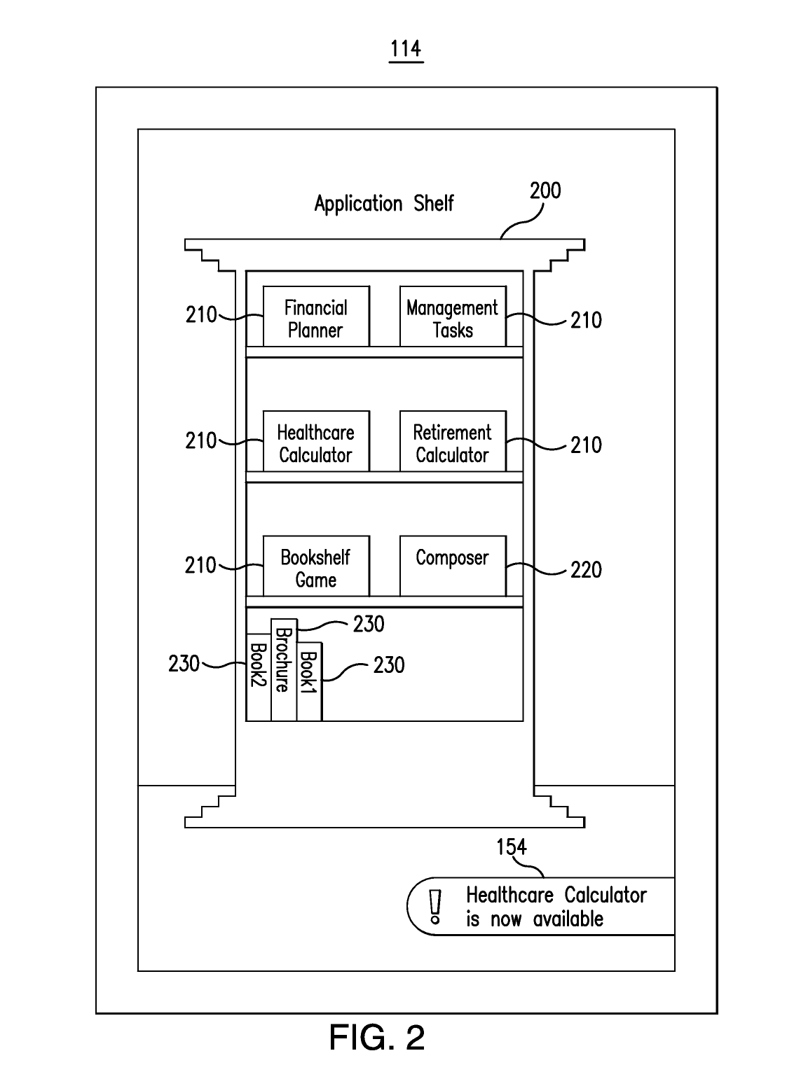

FIGS. 2 through 4 illustrate a device 114 of system 100 providing particular interfaces for the user 112. For example, device 114 may provide an interface that shows the available literature 160 and applications 140 to user 112. As another example, device 114 may provide an interface through which user 112 may design and compose literature 160 and applications 140.

FIG. 2 illustrates a device 114 of the system 100 of FIG. 1 for presenting applications 140 and literature 160. Device 114 may provide an interface through which user 112 may see available applications 140 and literature 160.

The interface may include a shelf 200. Shelf 200 is an electronic representation of a bookshelf or any other suitable shelf for holding objects. Shelf 200 may provide user 112 with the context through which applications 140 and literature 160 may be visualized and opened and/or executed. For example, shelf 200 may include multiple rungs or shelves. Each shelf may hold objects representing literature 160 and/or applications 140. For example, applications 140 may be represented by boxes 210. In the example illustrated in FIG. 2, the shelf shows that the applications 140 that are available are titled “Financial Planner,” “Management Tasks,” “Healthcare Calculator,” “Retirement Calculator,” and “Bookshelf Game.” A user 112 may select one of these boxes 210 to execute the application associated with the box 210. Furthermore, the shelf 200 includes a box 220 for the composer. By selecting the box 220, user 112 may be taken to the interface through which user 112 may design and compose literature 160 and applications 140. Shelf 200 also holds books 230 associated with available literature 160. In the example illustrated in FIG. 2, shelf 200 holds books 230 associated with “Book One,” “Book Two,” and “Brochure.” When user 112 selects one of these books 230, device 114 may display the contents of the associated literature 160.

Device 114 may present an alert 154 to indicate that a new application 140 or literature 160 has become available. In the example illustrated in FIG. 2, device 114 is presenting an alert 154 indicating that the healthcare calculator application is now available. As indicated by the alert 154, shelf 200 holds a box 210 associated with the healthcare calculator. If user 112 selects the box 210 associated with the healthcare calculator, device 114 may request and execute the healthcare calculator application.

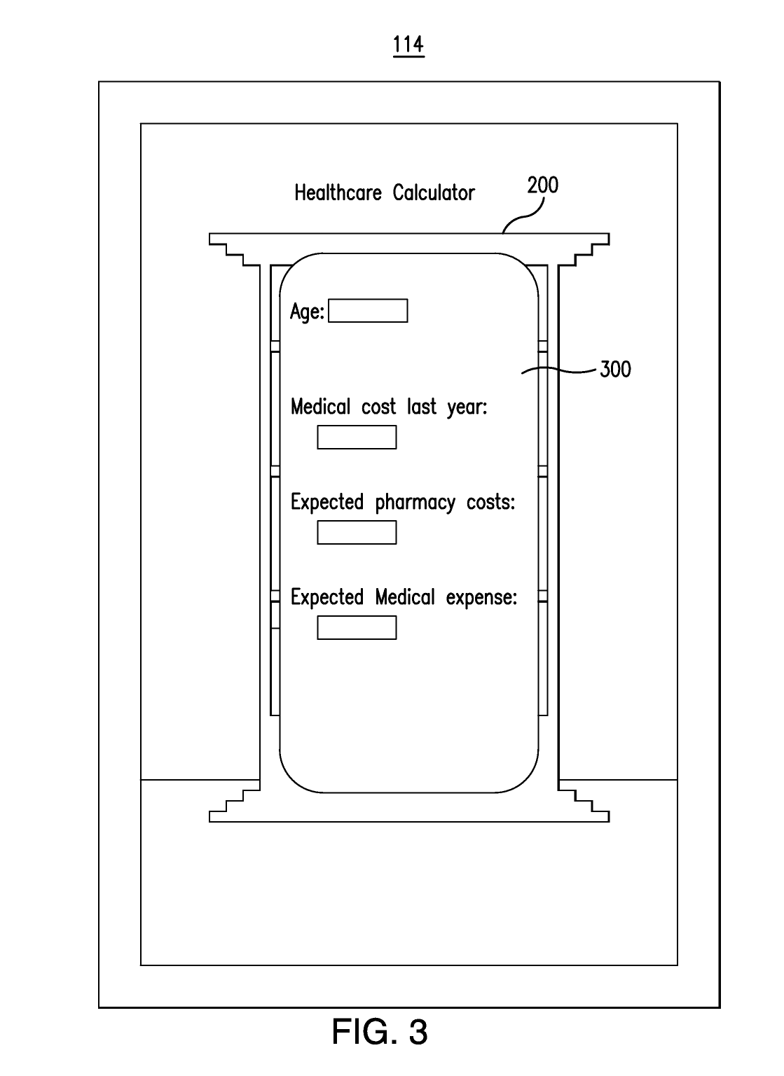

FIG. 3 illustrates a device 114 of the system 100 of FIG. 1 for presenting applications 140 and literature 160. As provided in FIG. 3, device 114 may present a shelf 200 and a viewer 300. Device 114 may present the contents of literature 160 or the results of executing an application 140 in viewer 300. In the example illustrated in FIG. 3, device 114 is executing an application 140 titled healthcare calculator. The healthcare calculator generates a display in viewer 300 that shows text fields in which user 112 may enter age, medical costs last year, and expected pharmacy costs. After user 112 enters the information, the healthcare calculator may calculate the expected medical expenses for user 112. Similarly, if user 112 had selected to view a piece of literature 160, such as a medical brochure, device 114 may present the contents of the medical brochure in viewer 300.

Portions of the shelf 200 may frame viewer 300. For example, the edges of shelf 200 may extend beyond the borders of viewer 300. This disclosure contemplates shelf 200 extending beyond any suitable number of sides of viewer 300. For example, shelf 200 may extend beyond four borders of a rectangular viewer 300. As another example, shelf 200 may extend beyond three borders of a rectangular viewer 300. This disclosure further contemplates viewer 300 being of any suitable shape and/or design. For example, if user 112 selects a piece of literature 160, viewer 300 may resemble an open book and the contents of the literature 160 may be presented on the pages of the book.

Device 114 may further present animations in response to particular user actions. For example, if user 112 selects a book 230 associated with a particular piece of literature 160, device 114 may present an animation where the book 230 is pulled off the shelf and opened. The pages of the book 230 may then act as the viewer 300 displaying the contents of the literature 160. As another example, if user 112 selects a box 210 associated with an application 140, device 114 may present an animation where the box is pulled off the shelf and opened to reveal its contents as the viewer 300. This disclosure contemplates any suitable animation in response to any suitable user action. For example, when user 112 closes down the application 116, the device 114 may present animation where the lights in the room containing the shelf 200 are turned off.

In this manner, device 114 may provide an interactive and immersive user experience for viewing literature 160 and executing applications 114. By showing the viewer 300 in the context of shelf 200, device 114 may present the user 112 with a single context even though the user 112 may be viewing different types of literature 160 and executing different types of applications 140.

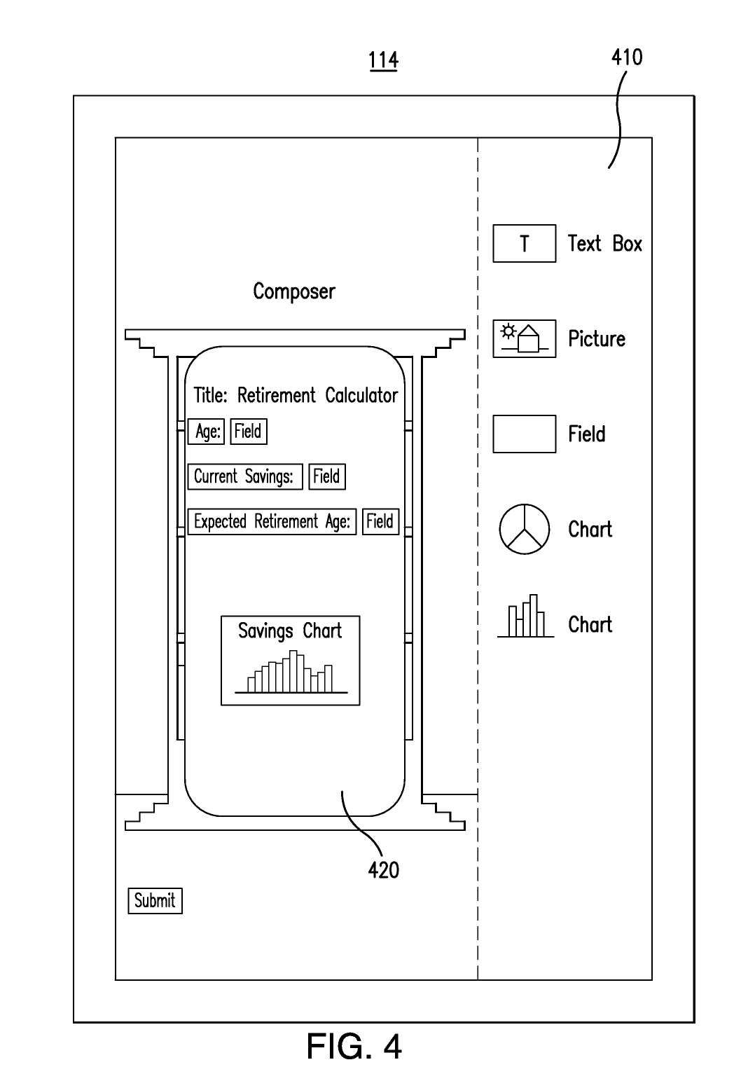

FIG. 4 illustrates a device 114 of the system 100 of FIG. 1 for composing applications 140 and literature 160. As provided by FIG. 4, device 114 may present an interface through which user 112 may compose and design literature 160 and applications 140. The interface may include a list 410 of items and a composer area 420.

The interface may provide a list 410 of items that user 112 may drag and drop into the composer area 420. This disclosure contemplates the list 410 including any suitable items that may be used in the design of literature 160 and/or an application 140. In the example illustrated in FIG. 4, the list 410 includes a text box, a picture, a field, a pie chart, and a line chart. User 112 may select any item and drag it into the composer area 420. By dragging a particular item into the composer area, user 112 indicates to include the item in the application's design. For example, user 112 may drag a picture into the composer area 420 to indicate that the design literature 160 and/or application 140 should include a picture in the designated area. User 112 may then specify the picture to include.

The composer area 420 may include the design of literature 160 and/or application 140. In the example illustrated in FIG. 4, the composer area 420 includes a title region where user 112 may indicate the title of the application 140 and/or literature 160. In the example, the user is designing an application 140 titled “Retirement Calculator.” The composer area 420 further shows text boxes labeled age, current savings, and expected retirement age. The composer area 420 also includes fields next to each of these text boxes. When the retirement calculator is executed, a user 112 will see fields that the user 112 may populate with his age, current savings, and expected retirement age. The composer area 420 further includes a line chart titled savings chart. When the user 112 executes the retirement calculator, the savings chart may be populated based on the age, current savings, and expected retirement age provided by user 112.

When user 112 has finished designing and/or composing literature 160 or application 140, user 112 may submit the literature 160 or application 140. Upon submission, server 110 may store the completed literature 160 and/or application 140. Server 110 may further publish the completed application 140 and/or literature 160 to designated users 112 based on a permission 170. In this manner, device 114 provides an intuitive interface through which user 112 may design and/or compose literature 160 and/or applications 140 for other users 112.

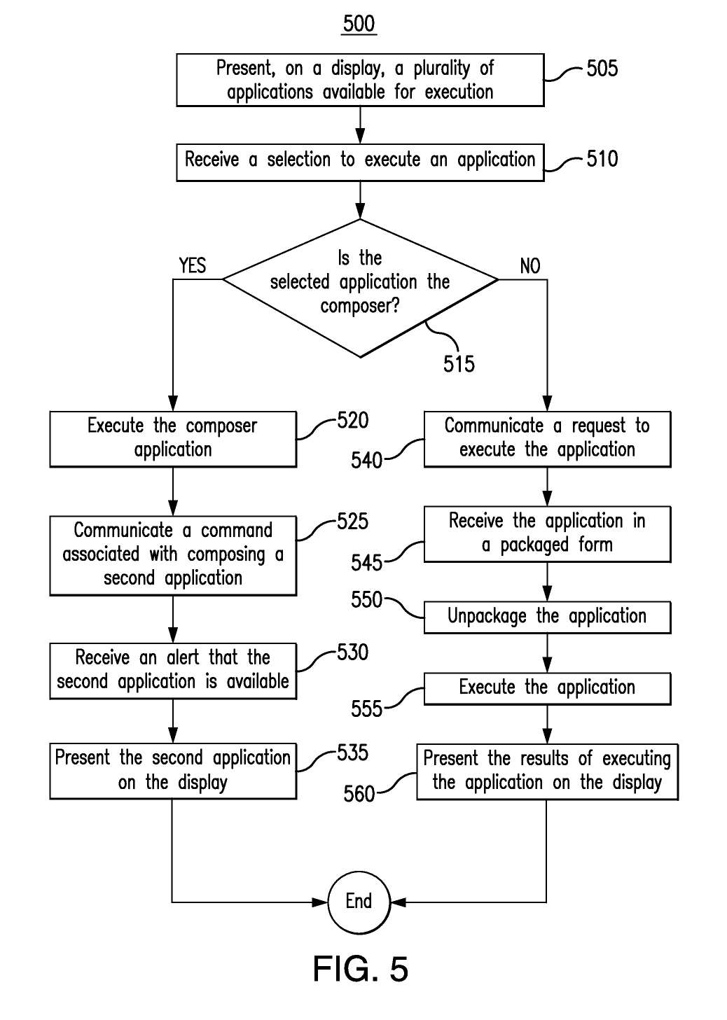

FIG. 5 is a flowchart illustrating a method 500 of presenting and composing applications 140 and literature 160. Device 114 may perform method 500. By performing method 500, device 114 may provide in interface through which user 112 may view literature 160, execute applications 140, and design and/or compose literature 160 and applications 140. The description of method 500 will be in the context of applications 140. However, device 114 may similarly perform method 500 in the context of literature 160.

Device 114 presents a plurality of applications available for execution on a display in step 505. In an embodiment, server 110 communicates a message 142 to device 114 that indicates the available applications. Device 114 may receive the message 142 and present the applications available for execution on the display. In step 510, device 114 may receive a selection to execute an application from the plurality of applications in step 510. In step 515, device 114 determines whether the selected application is the composer. If the selected application is the composer, this indicates user's 112 desire to design and/or compose an application. If the selected application is not the composer, this indicates user's 112 desire to execute an application.

If the selected application is the composer, device 114 executes the composer application in step 520. The composer application may provide an interface through which user 112 may design and/or compose an application. User 112 may perform particular actions to compose and/or design the application. For example, user 112 may drag and drop text boxes, text fields, pictures, charts, and any other suitable items into the interface to design and/or compose the application. When the user performs the particular action, device 114 may continue to step 525 and communicate a command associated with that action. The action may be communicated to server 110.

After the user has finished composing and/or designing the application, server 110 may store the completed application and publish it to designated users 112. By publishing the application, server 110 may notify the designated users 112 that the application is available. Server 110 may communicate an alert to notify the designated users 112. In step 530, device 110 may receive one of these alerts that the application is available for execution. In response to receiving the alert, device 114 may present the application on the display in step 535. In the example interfaces described in this disclosure, device 114 may present the application on a shelf.

If the selected application is not the composer, device 114 communicates a request to execute the selected application in step 540. The request may be communicated to server 110 and may include a title and/or an identifier associated with the selected application. Server 110 may receive the request and package the selected application. Packaging may include compiling and/or attaching an installer to the selected application so that device 114 may properly execute the application. After the selected application has been packaged, server 110 may communicate it to device 114.

In step 545, device 114 may receive the application in a packaged form. In step 550, device 114 may unpackage the application. Unpackaging may include installing the application and/or decompressing the application. After the application has been unpackaged, device 114 may continue to step 555 to execute the application.

During execution, device 114 may present the results of executing the application on the display in step 560. Device 114 may present the results in a viewer. The viewer may take any suitable shape and/or form. In particular embodiments, the viewer may be shown in the same context in which the device presented the plurality of applications available for execution. For example, the shelf containing the applications available for execution may frame the viewer.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. One or more computer-readable non-transitory storage media embodying software that is operable when executed to:
present, on a display, a plurality of applications available for execution;
receive a selection of an application from the plurality of applications;
communicate a request associated with the application in response to receiving the selection;
receive, in response to the request, the application in a packaged form wherein, the packaged form corresponds to an operating system associated with the media;
unpackage the application in order for the application to be executed; and
present, on the display, the results of executing the application.

2. The media of claim 1 embodying software that is further operable, when executed, to:
present, on the display, an interface through which a second application may be composed;
receive a command associated with composing the second application; and
communicate the command.

3. The media of claim 2 wherein the interface allows for a portion of the second application to be dragged-and-dropped into the interface.

4. The media of claim 2 embodying software that is further operable, when executed, to present, on the display, the second application along with the plurality of applications.

5. The media of claim 2 embodying software that is further operable, when executed, to receive an alert indicating that the second application is available.

6. The media of claim 1 embodying software that is further operable, when executed, to present a shelf on a region of the display, wherein the plurality of applications are presented on the region of the display.

7. The media of claim 6 embodying software that is further operable, when executed to present, on the display, at least a portion of the shelf forming a border around the results of executing the application.

8. The media of claim 1 embodying software that is further operable, when executed, to present, on the display, an animation associated with executing the application.

9. The media of claim 1 embodying software that is further operable, when executed, to communicate authentication parameters.

10. An apparatus comprising:
a memory operable to store a plurality of applications; and
a processor communicatively coupled to the memory and operable to:
receive a request associated with initiating execution of an application in the plurality of applications;
package the application based at least in part upon an operating system associated with the request; and
communicate at least a portion of the packaged application in response to the request in order for the application to execute.

11. The apparatus of claim 10, wherein the processor is further operable to:
receive a command associated with composing a second application;
compose at least a portion of the second application in response to receiving the command; and
add the second application to the plurality of applications.

12. The apparatus of claim 11, wherein the processor is further operable to communicate an alert indicating that the second application is available.

13. The apparatus of claim 10, wherein the processor is further operable to log at least one of the requests associated with initiating execution of the application and the results of executing the application.

14. The apparatus of claim 10, wherein the processor is further operable to block at least a portion of a communication based at least in part upon a permission associated with the application.

15. A method comprising:
presenting, on a display, a plurality of applications available for execution;
receiving a selection of an application to execute from the plurality of applications;
communicating, by a processor, a request associated with the application in response to receiving the selection;
receiving, in response to the request, the application in a packaged form, wherein:
the package form is recognizable by the processor; and
the packaged form corresponds to an operating system associated with the processor;
unpackaging, by the processor, the application in order to execute the application; and
presenting, on the display, the results of executing the application.

16. The method of claim 15 further comprising:
presenting, on the display, an interface through which a second application may be composed;
receiving a command associated with composing the second application; and
communicating, by the processor, the command.

17. The method of claim 15 further comprising presenting a shelf on a region of the display, wherein the plurality of applications are presented on the region of the display.

18. The method of claim 17 further comprising presenting, on the display, at least a portion of the shelf forming a border around the results of executing the application.

19. The method of claim 15 further comprising presenting, on the display, an animation associated with executing the application.

20. The method of claim 15 further comprising:
presenting, on the display, an interface through which a second application may be composed;
receive a command associated with composing the second application; and
communicate the command.
